(19) United States
(12) Patent Application Publication
(10) Pub. No.: US 2004/0242426 A1
(43) Pub. Date: Dec. 2, 2004

(54) New derivatives of substituted anilined with herbicidal activity

(76) Inventors: Franco Bettarini, Novara (IT); Giovanni Meazza, Saronno-Varesse (IT); Paolo Sapino, Novara (IT); Domenico Portoso, Lodi (IT); Luca Fornara, Cerro AL Lambro (IT)

Correspondence Address: James V Costigan, Hedman & Costigan, 1185 Avenue Of The Americas, New York, NY, 10036-2601, US

(21) Appl. No.: 10/482,636

(22) PCT Filed: Jul. 12, 2002
(86) PCT No.: PCT/IB02/02790

(30) Foreign Application Priority Data
Jul. 13, 2001 (IT) M101A001497

(51) Int. Cl. A01N 37/18

(52) U.S. Cl. 504/336; 564/170

(57) ABSTRACT

Compounds having general formula (I): wherein: —R represents a hydrogen atom, a C₁-C₈ alkyl or haloalkyl group, a C₂-C₈ alkoxyalkyl or haloalkoxyalkyl group, a C₂-C₈ alkenyl or haloalkenyl group, a C₂-C₈ alkinyl or haloalkinyl group, a C₃-C₈ cycloalkyl or C₄-C₉ cycloalkylalkyl group optionally substituted by halogen atoms and/or C₁-C₄ alkyl or haloalkyl groups, a C₂-C₈ alkoxyl or haloalkoxyl group, an NRₐR_{b} group; Rₐ and R_{b}, the same or different, represent: a hydrogen atom; a C₁-C₈ alkyl group; a phenyl group or a benzyl group optionally substituted by halogen atoms, by CN groups, NO₂ groups, C₁-C₄, haloalkyl, alkoxyl, haloalkoxyl groups; or Rₐ and R_{b} jointly represent a C₂-C₈ alkylene chain optionally interrupted by oxygen atoms; Rₙ represents a hydrogen atom, or a C₁-C₄ alkyl or haloalkyl group; R₁ represents a hydrogen atom, a halogen atom, a C₁-C₄ alkyl or haloalkyl group, a C₁-C₄ alkoxyl or haloalkoxyl group, a C₁-C₄ alkylthio or haloalkylthio group, a cyano group, a nitro group; R₂ represents a C₁-C₄ alkyl, haloalkyl, alkoxyl, haloalkoxyl, alkylthio or haloalkylthio group, or a halogen atom; X and X₁, the same or different, represent a hydrogen atom or a halogen atom; A represents an oxygen atom, a —CR₃R₄O-group, an —OCR₃R₄— group wherein R₃ and R₄, the same or different, represent a hydrogen atom or a C₁-C₄ alkyl, haloalkyl group.

The present invention relates to new derivatives of substituted anilines.

More specifically, the present invention relates to new derivatives of ortho-substituted anilines having a high herbicidal activity, the processes for its preparation and their use as herbicides for controlling weeds in agricultural crops.

Derivatives of meta-substituted anilines with a herbicidal activity are described in German patent application 2,855,699. These compounds however do not appear to be satisfactory as herbicides in that they require high applicative dosages.

Heterocyclyl- or phenyl-carboxanilides substituted, in “ortho” position with respect to the amine group, by variously substituted phenoxy, phenoxymethyl or phenylmethoxy groups, are described in patent application WO 98/03500. The products of the above patent application are essentially active as fungicides and insecticides.

The applicant has now found that a series of new derivatives of anilines substituted, in “ortho” position with respect to the amine group, by phenoxymethyl, phenylmethoxy or phenoxy groups, in turn substituted by particular groupings, have, on the contrary, a surprisingly high herbicidal activity, combined with a low phytotoxicity for one or more cultivations of agrarian interest.

The object of the present invention therefore relates to new compounds having general formula (I):

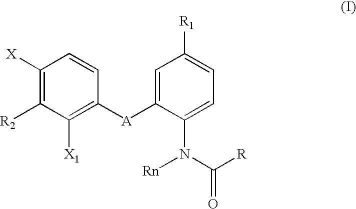

wherein:

R represents a hydrogen atom, a C₁-C₈ alkyl or haloalkyl group, a C₂-C₈ alkoxyalkyl or haloalkoxyalkyl group, a C₂-C₈ alkenyl or haloalkenyl group, a C₂-C₈ alkinyl or haloalkinyl group, a C₃-C₈ cycloalkyl or C₄-C₉ cycloalkylalkyl group optionally substituted by halogen atoms and/or C₁-C₄ alkyl or haloalkyl groups, a C₁-C₈ alkoxyl or haloalkoxyl group, an NRₐR_{b} group;

Rₐ and R_{b}, the same or different, represent: a hydrogen atom; a C₁-C₈ alkyl group; a phenyl group or a benzyl group optionally substituted by halogen atoms, by CN groups, NO₂ groups, C₁-C₄ alkyl, haloalkyl, alkoxyl, haloalkoxyl groups; or Rₐ and R_{b} jointly represent a C₂-C₈ alkylene chain optionally interrupted by oxygen atoms;

Rₙ represents a hydrogen atom, or a C₁-C₄ alkyl or haloalkyl group;

R₁ represents a hydrogen atom, a halogen atom, a C₁-C₄ alkyl or haloalkyl group, a C₁-C₄ alkoxyl or haloalkoxyl group, a C₁-C₄ alkylthio or haloalkylthio group, a cyano group, a nitro group;

R₂ represents a C₁-C₄ alkyl, haloalkyl, alkoxyl, haloalkoxyl, alkylthio or haloalkylthio group, or a halogen atom;

X and X₁, the same or different, represent a hydrogen atom or a halogen atom;

A represents an oxygen atom, a —CR₃R₄O— group, an —OCR₃R₄— group wherein R₃ and R₄, the same or different, represent a hydrogen atom or a C₁-C₄ alkyl, haloalkyl group.

Specific examples of compounds having general formula (I) which are of interest for their activity are specified in Table 1:

TABLE 1

| X | X₁ | R₂ | A | R₁ | Rₙ | R |
|---|---|---|---|---|---|---|
| H | H | CF₃ | CH₂O | CH₃ | H | cyclopropyl |
| H | H | CF₃ | OCH₂ | CH₃ | H | cyclopropyl |
| H | H | CF₃ | O | CH₃ | H | cyclopropyl |
| H | H | CF₃ | CH₂O | CH₃ | H | isopropyl |
| H | H | CF₃ | OCH₂ | CH₃ | H | isopropyl |
| H | H | CF₃ | O | CH₃ | H | isopropyl |
| H | H | CF₃ | CH₂O | CH₃ | H | n-propyl |
| H | H | CF₃ | OCH₂ | CH₃ | H | n-propyl |
| H | H | CF₃ | O | CH₃ | H | n-propyl |
| H | H | CF₃ | CH₂O | CH₃ | H | ethyl |
| H | H | CF₃ | OCH₂ | CH₃ | H | ethyl |
| H | H | CF₃ | O | CH₃ | H | ethyl |
| H | H | CF₃ | CH₂O | CH₃ | H | methyl |
| H | H | CF₃ | OCH₂ | CH₃ | H | methyl |
| H | H | CF₃ | O | CH₃ | H | methyl |
| H | H | CF₃ | CH₂O | CH₃ | H | CICH₂ |
| H | H | CF₃ | OCH₂ | CH₃ | H | CICH₂ |
| H | H | CF₃ | O | CH₃ | H | CICH₂ |
| H | H | CF₃ | CH₂O | CH₃ | H | H |
| H | H | CF₃ | OCH₂ | CH₃ | H | H |
| H | H | CF₃ | O | CH₃ | H | H |
| F | H | CF₃ | OCH₂ | CH₃ | H | cyclopropyl |
| F | H | CF₃ | O | CH₃ | H | cyclopropyl |
| H | H | OCF₂H | CH₂O | CH₃ | H | cyclopropyl |
| H | H | OCF₂H | OCH₂ | CH₃ | H | cyclopropyl |
| H | H | OCF₂H | O | CH₃ | H | cyclopropyl |
| H | H | OCF₂H | CH₂O | CH₃ | H | isopropyl |
| H | H | OCF₂H | OCH₂ | CH₃ | H | isopropyl |
| H | H | OCF₂H | O | CH₃ | H | isopropyl |
| H | H | CF₃ | CH₂O | CH₃ | H | 1-methylcyclopropyl |
| H | H | CF₃ | OCH₂ | CH₃ | H | 1-methylcyclopropyl |
| H | H | CF₃ | O | CH₃ | H | 1-methylcyclopropyl |
| H | H | CF₃ | CH₂O | CH₃ | H | cyclobutyl |
| H | H | CF₃ | OCH₂ | CH₃ | H | cyclobutyl |
| H | H | CF₃ | O | CH₃ | H | cyclobutyl |
| H | H | CF₃ | CH₂O | CH₃ | H | cyclopentyl |
| H | H | CF₃ | OCH₂ | CH₃ | H | cyclopentyl |
| H | H | CF₃ | O | CH₃ | H | cyclopentyl |
| H | H | CF₃ | CH₂O | CH₃ | H | isobutyl |
| H | H | CF₃ | OCH₂ | CH₃ | H | isobutyl |
| H | H | CF₃ | O | CH₃ | H | isobutyl |
| H | H | CF₃ | CH₂O | CH₃ | H | CH₃OCH₂ |
| H | H | CF₃ | OCH₂ | CH₃ | H | CH₃OCH₂ |
| H | H | CF₃ | O | CH₃ | H | CH₃OCH₂ |
| H | H | CF₃ | CH₂O | CH₃ | H | (CH₃)₂N |
| H | H | CF₃ | OCH₂ | CH₃ | H | (CH₃)₂N |
| H | H | CF₃ | O | CH₃ | H | (CH₃)₂N |
| H | H | CF₃ | CH₂O | CH₃ | H | 1-pyrrolidyl |
| H | H | CF₃ | OCH₂ | CH₃ | H | 1-pyrrolidyl |
| H | H | CF₃ | O | CH₃ | H | 1-pyrrolidyl |
| H | H | CF₃ | CH₂O | CH₃ | H | 1-morpholyl |
| H | H | CF₃ | OCH₂ | CH₃ | H | 1-morpholyl |
| H | H | CF₃ | O | CH₃ | H | 1-morpholyl |
| H | H | CF₃ | CH₂O | H | H | cyclopropyl |
| H | H | CF₃ | OCH₂ | H | H | cyclopropyl |
| H | H | CF₃ | O | H | H | cyclopropyl |
| H | H | CF₃ | CH₂O | F | H | cyclopropyl |
| H | H | CF₃ | OCH₂ | F | H | cyclopropyl |
| H | H | CF₃ | O | F | H | cyclopropyl |
| H | H | CF₃ | OCH₂ | Cl | H | cyclopropyl |
| H | H | CF₃ | CH₂O | CH₃ | H | CH₃O |
| H | H | CF₃ | OCH₂ | CH₃ | H | CH₃O |
| H | H | CF₃ | O | CH₃ | H | CH₃O |
| H | H | CF₃ | CH₂O | CH₃ | H | CH₃CH₂O |
| H | H | CF₃ | OCH₂ | CH₃ | H | CH₃CH₂O |
| H | H | CF₃ | O | CH₃ | H | CH₃CH₂O |
| H | F | CF₃ | CH₂O | CH₃ | H | cyclopropyl |
| H | F | CF₃ | OCH₂ | CH₃ | H | cyclopropyl |
| H | F | CF₃ | O | CH₃ | H | cyclopropyl |

A further object of the present invention relates to processes for the preparation of the compounds having general formula (I).

The compounds having general formula (I) can be prepared by the reaction of an amine derivative having general formula (II) with a compound having general formula (III), according to reaction scheme 1:

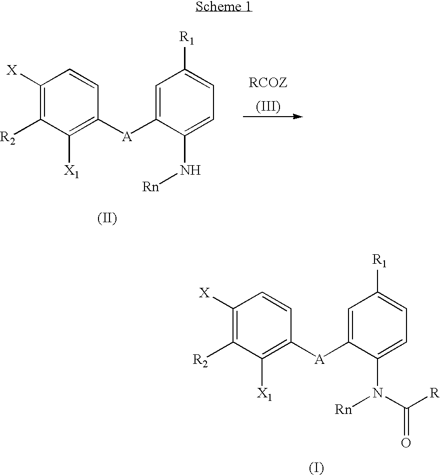

In said formulae, R, Rₙ, R₁, R₂, X, X₁ and A have the meanings described above, Z represents a halogen atom, an alkoxyl group, a hydroxyl group.

The reaction conditions for carrying out the above process can also vary in relation to the nature of the compound having formula (III).

For example, when Z represents a halogen atom, the reaction is preferably carried out in the presence of an inert solvent and in the presence of an organic or inorganic base, at a temperature ranging from −20° C. to the boiling point of the reaction mixture.

Examples of solvents which can be used for the above reaction include water, aliphatic or cycloaliphatic hydrocarbons (petroleum ether, hexane, cyclohexane, etc.), chlorinated hydrocarbons (methylene chloride, chloroform, carbon tetrachloride, dichloroethane, etc.), aromatic hydrocarbons (benzene, toluene, xylene, chlorobenzene, etc.), ethers (diethyl ether, diisopropyl ether, dimethoxyethane, dioxane, tetrahydrofuran, etc.), esters (ethyl acetate, etc.), ketones (acetone, methylethylketone, methylpropyl-ketone, methylisobutyl ketone, etc.), nitriles (acetonitrile, benzonitrile, etc.), aprotic dipolar solvents (dimethylformamide, dimethylacetamide, hexamethylphosphorotriamide, dimethylsulfoxide, sulfolane, N-methylpyrrolidone, etc.).

Inorganic bases which can be used for the purpose are, for example, hydroxides, sodium and potassium carbonates and bicarbonates.

Organic bases which can be used for the purpose are, for example, triethylamine, pyridine, 4-N,N-dimethylaminopyridine, N,N-dimethylaniline, N-methylpiperidine, lutidine, diazabicyclooctane (DABCO), diazabicyclononene (DBN), diazabicycloundecene (DBU).

Alternatively, the compounds having general formula (I) wherein A represents a —CR₃R₄O— group, can be prepared by the condensation of a derivative having general formula (IV) with a phenol having general formula (V), to give an ether having general formula (Ia) according to reaction scheme 2:

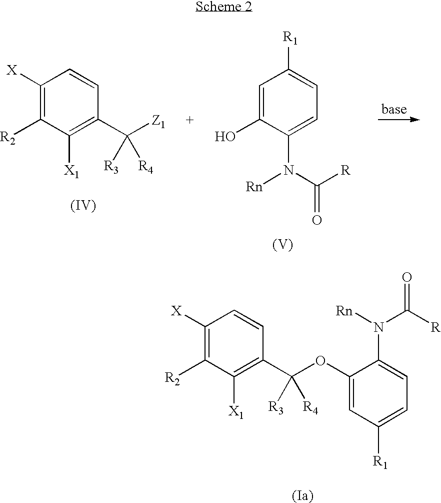

In the general formulae specified in this reaction scheme, R, Rₙ, R₁, R₂, R₃, R₄, X and X₁ have the meanings previously defined, Z₁ represents a halogen atom, preferably chlorine or bromine, or an R_{z}SO₃ group wherein R_{z} represents a C₁-C₄ alkyl group or a phenyl group optionally substituted by C₁-C₄ alkyl groups.

The etherification reaction is preferably carried out in the presence of one or more inert organic solvents and in the presence of a base, preferably inorganic, at a temperature ranging from −10° C. to the boiling point of the reaction mixture.

Organic solvents which can be used for the purpose are, for example, aromatic hydrocarbons (benzene, toluene, xylene, chlorobenzene, etc.), ethers (diethyl ether, diisopropyl ether, dimethoxyethane, dioxane, tetrahydrofuran, etc.), alcohols and glycols (methanol, ethanol, methycellosolve, ethylene glycol, etc.), ketones (acetone, methylethylketone, methylpropylketone, methylisobutylketone, etc.), nitriles (acetonitrile, benzonitrile, etc.), aprotic dipolar solvents (dimethylformamide, dimethylacetamide, hexamethylphosphorotriamide, dimethylsulfoxide, sulfolane, N-methylpyrrolidone, etc.).

Inorganic bases useful for the purpose are, for example, sodium or potassium hydrides, hydroxides and carbonates.

The reaction can be advantageously carried out in a biphasic system using water and an organic solvent immiscible therewith, as solvents, in the presence of phase transfer catalysts, according to what is described by Dehmlow and Dehmlow in “Phase Transfer Catalysis” (1983), Verlag Chemie.

Analogously, the compounds having general formula (I) wherein A represents an —OCR₃R₄— group, can be alternatively prepared by the reaction of a phenol having general formula (VI) with a derivative having general formula (VII), to give an ether having general formula (Ib) according to reaction scheme 3:

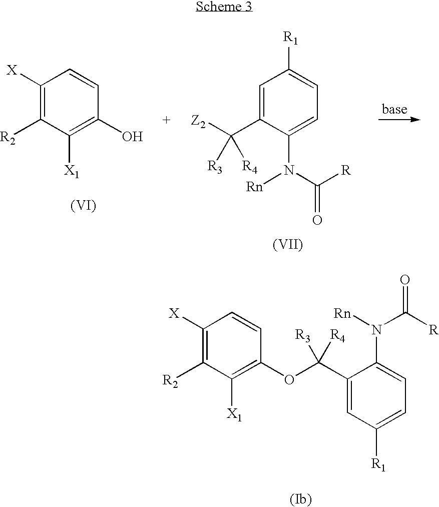

In the general formulae specified in this reaction scheme, R, Rₙ, R₁, R₂, R₃, R₄, X and X₁ have the meanings previously defined, Z₂ represents a halogen atom, preferably chlorine or bromine, or an R_{z}SO₃ group wherein R_{z} represents a C₁-C₄ alkyl group or a phenyl group optionally substituted by C₁-C₄ alkyl groups.

The operating procedure, as well as the type of solvents and bases which can be used for the etherification reaction defined in scheme 3, are entirely analogous to those specified for the reaction of scheme 2.

The intermediates having general formulae (II), (III), (IV), (V), (VI) and (VII), when not already known in themselves, can be easily prepared according to methods known in organic chemical practice.

As already mentioned, the compounds having general formula (I) have a high herbicidal activity which makes them suitable for use in the agrarian field to protect useful crops from weeds.

In particular, the compounds object of the present invention are effective in both the pre-emergence and post-emergence control of numerous monocotyledon and dicotyledon weeds. At the same time, these compounds show compatibility or the absence of toxic effects with respect to useful crops in pre- and/or post-emergence treatment.

Examples of weeds which can be effectively controlled using the compounds having general formula (I) are: Abutilon theofrasti, Alisma plantago, Amaranthus spp., Amni maius, Capsella bursa pastoris, Chenopodium album, Convolvulus sepium, Galium aparine, Geranium dissectum, Ipomea spp., Matricaria spp., Papaver rhoeas, Phaseolus aureus, Polygonum persicaria, Portulaca oleracea, Sida spinosa, Sinapis arvensis, Solanum nigrum, Stellaria media, Veronica spp., Viola spp., Xanthium spp., Alopecurus myosuroides, Avena fatua, Cyperus spp., Digitaria sanguinalis, Echinocloa spp., Heleocaris avicularis, Heteranthera spp., Panicum spp., Poa spp., Scirpus spp., Sorghum spp., etc.

With the doses used for agrarian applications, the above compounds have not shown any toxic effects towards any of the important agrarian crops such as rice (Oryza sativa), wheat (Triticum sp.), barley (Hordeum vulgare), maize (Zea mays), soybean (Glycine max).

A further object of the present invention relates to a method for controlling weeds in cultivated areas by the application of the compounds having general formula (I).

The quantity of compound to be applied for obtaining the desired effect can vary in relation to various factors such as, for example, the compound used, the crop to be preserved, the weed to be destroyed, the degree of infestation, the climatic conditions, the characteristics of the ground, the application method, etc.

Doses of compound ranging from 1 g to 1000 g per hectare generally provide sufficient control.

For use in agriculture, it is often advantageous to use compositions with a herbicidal activity containing, as active substance, one or more compounds having general formula (I), also possibly as a mixture of isomers.

Compositions can be used, in the form of dry powders, wettable powders, emulsifiable concentrates, microemulsions, pastes, granulates, solutions, suspensions, etc.: the selection of the type of composition depends on the specific use.

The compositions are prepared according to the known methods, for example by diluting or dissolving the active substance with a solvent and/or solid diluent medium, optionally in the presence of surface-active agents.

Kaolin, alumina, silica, talc, bentonite, chalk, quartz, dolomite, attapulgite, montmorillonite, diatomaceous earth, cellulose, starch, etc., can be used as solid inert diluents, or carriers.

Water, or organic solvents such as aromatic hydrocarbons (xylols, mixtures of alkylbenzols, etc.), aliphatic hydrocarbons (hexane, cyclohexane, etc.), halogenated aromatic hydrocarbons (chlorobenzol, etc.), alcohols (methanol, propanol, butanol, octanol, etc.), esters (isobutyl acetate, etc.), ketones (acetone, cyclohexanone, acetophenone, isophorone, ethylamylketone, etc.), or vegetable or mineral oils or their mixtures, etc., can be used as liquid inert diluents.

Wetting and emulsifying agents of the non-ionic type (polyethoxylated alkylphenols, polyethoxylated fatty alcohols, etc.), of the anionic type (alkylbenzenesulfonates, alkylsulfonates, etc.), of the cationic type (quaternary salts of alkylammonium, etc.), can be used as surface-active agents.

Dispersing agents (for example lignin and its salts, derivatives of cellulose, alginates, etc.), stabilizers (for example antioxidants, ultraviolet-ray absorbers, etc.), can also be added.

In order to broaden the action range of the above compositions, it is possible to add other active ingredients such as, for example, other herbicides, fungicides, insecticides, acaricides, fertilizers, etc.

Examples of other herbicides which can be added to the compositions containing one or more compounds having general formula (I) are the following: acetochlor, acifluorfen, aclonifen, AKH-7088, alachlor, alloxydim, ametryn, amicarbazone, amidosulfuron, amitrole, anilofos, asulam, atrazine, azafenidin, azimsulfuron, aziprotryne, BAY MKH 6561, beflubutamid, benazolin, benfluralin, benfuresate, bensulfuron, bensulide, bentazone, benzfendizone, benzobicyclon, benzofenap, benzthiazuron, bifenox, bilanafos, bispyribac-sodium, bromacil, bromobutide, bromofenoxim, bromoxynil, butachlor, butafenacil, butamifos, butenachlor, butralin, butroxydim, butylate, cafenstrole, carbetamide, carfentrazone-ethyl, chlomethoxyfen, chloramben, chlorbromuron, chlorbufam, chlorflurenol, chloridazon, chlorimuron, chlornitrofen, chlorotoluron, chloroxuron, chlorpropham, chlorsulfuron, chlorthal, chlorthiamid, cinidon ethyl, cinmethylin, cinosulfuron, clethodim, clodinafop, clomazone, clomeprop, clopyralid, cloransulam-methyl, cumyluron (JC-940), cyanazine, cycloate, cyclosulfamuron, cycloxydim, cyhalofop-butyl, 2,4-D, 2,4-DB, daimuron, dalapon, desmedipham, desmetryn, dicamba, dichlobenil, dichlorprop, dichlorprop-P, diclofop, diclosulam, diethatyl, difenoxuron, difenzoquat, diflufenican, diflufenzopyr, dimefuron, dimepiperate, dimethachlor, dimethametryn, dimethenamid, dinitramine, dinoseb, dinoseb acetate, dinoterb, diphenamid, dipropetryn, diquat, dithiopyr, 1-diuron, eglinazine, endothal, EPTC, esprocarb, ethalfluralin, ethametsulfuron-methyl, ethidimuron, ethiozin (SMY 1500), ethofumesate, ethoxyfen-ethyl (HC-252), ethoxysulfuron, etobenzanid (HW 52), fenoxaprop, fenoxaprop-P, fentrazamide, fenuron, flamprop, flamprop-M, flazasulfuron, florasulam, fluazifop, fluazifop-P, fluazolate (JV 485), flucarbazone-sodium, fluchloralin, flufenacet, flumetsulam, flumiclorac-pentyl, flumioxazin, flumipropin, fluometuron, fluoroglycofen, fluoronitrofen, flupoxam, flupropanate, flupyrsulfuron, flurenol, fluridone, flurochloridone, fluroxypyr, flurtamone, fluthiacet-methyl, fomesafen, foramsulfuron, fosamine, furyloxyfen, glufosinate, glyphosate, halosulfuron-methyl, haloxyfop, haloxyfop-P-methyl, hexazinone, imazamethabenz, imazamox, imazapic, imazapyr, imazaquin, imazethapyr, imazosulfuron, indanofan, iodosulfuron, ioxynil, isopropalin, isoproturon, isouron, isoxaben, isoxachlortole, isoxaflutole, isoxapyrifop, KPP-421, lactofen, lenacil, linuron, LS830556, MCPA, MCPA-thioethyl, MCPB, mecoprop, mecoprop-P, mefenacet, mesotrione, metamitron, metazachlor, methabenzthiazuron, methazole, methoprotryne, methyldymron, metobenzuron, metobromuron, metolachlor, S-metolachlor, metosulam, metoxuron, metribuzin, metsulfuron, molinate, monalide, monolinuron, naproanilide, napropamide, naptalam, NC-330, neburon, nicosulfuron, nipyraclofen, norflurazon, orbencarb, oryzalin, oxadiargyl, oxadiazon, oxasulfuron, oxaziclomefone, oxyfluorfen, paraquat, pebulate, pendimethalin, pentanochlor, pentoxazone, pethoxamid, phenmedipham, picloram, picolinafen, piperophos, pretilachlor, primisulfuron, prodiamine, profluazol, proglinazine, prometon, prometryne, propachlor, propanil, propaquizafop, propazine, propham, propisochlor, propyzamide, prosulfocarb, prosulfuron, pyraclonil, pyraflufenethyl, pyrazolynate, pyrazosulfuron, pyrazoxyfen, pyribenzoxim, pyributicarb, pyridafol, pyridate, pyriftalid, pyriminobac-methyl, pyrithiobac-sodium, quinclorac, quinmerac, quizalofop, quizalofop-P, rimsulfuron, sethoxydim, siduron, simazine, simetryn, sulcotrione, sulfentrazone, sulfometuron-methyl, sulfosulfuron, 2,3,6-TBA, TCA-sodium, tebutam, tebuthiuron, tepraloxydim, terbacil, terbumeton, terbuthyl-azine, terbutryn, thenylchlor, thiazafluron, thiazopyr, thidiazimin, thifensulfuron-methyl, thiobencarb, tiocarbazil, tioclorim, tralkoxydim, tri-allate, triasulfuron, triaziflam, tribenuron, triclopyr, trietazine, trifloxysulfuron, trifluralin, triflusulfuron-methyl, tritosulfuron, UBI-C4874, vernolate.

The concentration of active substance in the above compositions can vary within a wide range, depending on the active compound, the applications for which they are destined, the environmental conditions and the type of formulation used.

In general, the concentration of active substance preferably ranges from 1 to 90%.

Some illustrative and non-limiting examples of the present invention are provided hereunder.

### EXAMPLE 1

Preparation of N-[4-methyl-2-(3-trifluoromethylphenyl)-methoxyphenyl]cyclopropanecarboxamide (C-1).

A solution of N-(2-hydroxy-4-methylphenyl)cyclopropanecarboxamide (1 g; 5.2 mmoles) in N,N-dimethylformamide (DMF; 13 ml), is prepared in a 100 ml flask, maintained under an atmosphere of nitrogen. Potassium carbonate is added (1 g; 7.2 mmoles), the mixture is kept under stirring at room temperature and a solution of 3-trifluoromethylbenzyl chloride (1.1 g; 5.6 mmoles) in DMF (2 ml) is added. The mixture is heated to 60° C. for 3 hours under stirring. After cooling, it is poured into water (150 ml), extracted with ethyl acetate (3×50 ml), the organic phase is washed with water (2×50 ml), anhydrified with sodium sulfate, filtered and concentrated. The raw product (1.6 g) is crystallized from a mixture of hexane/ethyl acetate 8:2: 1.3 g of a crystalline solid are obtained, with a melting point at 153-155° C.

### EXAMPLE 2

Preparation of N-[4-methyl-2-(3-trifluoromethylphenoxy)methylphenyl]cyclopropanecarboxamide (C-2).

A solution of cyclopropanecarbonyl chloride (0.54 g; 5.16 mmoles) in methylene chloride (5 ml) is added dropwise—at 0° C. and under stirring—to a mixture of 4-methyl-2-trifluoromethyl-phenoxymethyl)aniline (1.4 g; 5 mmoles) and triethylamine (0.55 g; 5.44 mmoles) in methylene chloride (15 ml) in a 100 ml flask, maintained under an atmosphere of nitrogen. The mixture is heated to reflux temperature for 3 hours under stirring. After cooling, the mixture is poured into water (150 ml), extracted with methylene chloride (3×50 ml), the organic phase is washed with water (2×50 ml), anhydrified with sodium sulfate, filtered and concentrated. 1.5 g of the desired product are obtained (¹H-NMR, elemental analysis).

### EXAMPLE 3

Operating analogously to what is described in Examples 1 and 2 above, the compounds (C) having general formula (I) indicated in Table 2 below, were prepared.

TABLE 2

| | |
|---|---|
| | (I) |
| 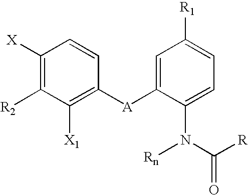 | |

| | | | | | | | | M.P. |
|---|---|---|---|---|---|---|---|---|
| C | X | X₁ | R₂ | A | R₁ | Rₙ | R | (° C.) |
| 1 | H | H | CF₃ | CH₂O | CH₃ | H | cyclopropyl | 153- |
| | | | | | | | | 155 |
| 2 | H | H | CF₃ | OCH₂ | CH₃ | H | cyclopropyl | |
| 3 | H | H | CF₃ | O | CH₃ | H | cyclopropyl | |
| 4 | H | H | CF₃ | CH₂O | CH₃ | H | isopropyl | |
| 5 | H | H | CF₃ | OCH₂ | CH₃ | H | isopropyl | |
| 6 | H | H | CF₃ | O | CH₃ | H | isopropyl | |
| 7 | H | H | CF₃ | CH₂O | CH₃ | H | n-propyl | |
| 8 | H | H | CF₃ | OCH₂ | CH₃ | H | n-propyl | |
| 9 | H | H | CF₃ | O | CH₃ | H | n-propyl | |
| 10 | H | H | CF₃ | CH₂O | CH₃ | H | ethyl | |
| 11 | H | H | CF₃ | OCH₂ | CH₃ | H | ethyl | |
| 12 | H | H | CF₃ | O | CH₃ | H | ethyl | |
| 13 | H | H | CF₃ | CH₂O | CH₃ | H | methyl | |
| 14 | H | H | CF₃ | OCH₂ | CH₃ | H | methyl | |
| 15 | H | H | CF₃ | O | CH₃ | H | methyl | |
| 16 | H | H | CF₃ | CH₂O | CH₃ | H | ClCH₂ | |
| 17 | H | H | CF₃ | OCH₂ | CH₃ | H | ClCH₂ | |
| 18 | H | H | CF₃ | O | CH₃ | H | ClCH₂ | |
| 19 | H | H | CF₃ | CH₂O | CH₃ | H | H | |
| 20 | H | H | CF₃ | OCH₂ | CH₃ | H | H | |
| 21 | H | H | CF₃ | O | CH₃ | H | H | |
| 22 | H | H | CF₃ | OCH₂ | CH₃ | H | cyclopropyl | |
| 23 | H | H | CF₃ | O | CH₃ | H | cyclopropyl | |
| 24 | H | H | OCF₂H | CH₂O | CH₃ | H | cyclopropyl | |
| 25 | H | H | OCF₂H | OCH₂ | CH₃ | H | cyclopropyl | |
| 26 | H | H | OCF₂H | O | CH₃ | H | cyclopropyl | |
| 27 | H | H | OCF₂H | CH₂O | CH₃ | H | isopropyl | |
| 28 | H | H | OCF₂H | OCH₂ | CH₃ | H | isopropyl | |
| 29 | H | H | OCF₂H | O | CH₃ | H | isopropyl | |
| 30 | H | H | CF₃ | CH₂O | CH₃ | H | 1-methylcyclopropyl | |
| 31 | H | H | CF₃ | OCH₂ | CH₃ | H | 1-methylcyclopropyl | |
| 32 | H | H | CF₃ | O | CH₃ | H | 1-methylcyclopropyl | |
| 33 | H | H | CF₃ | CH₂O | CH₃ | H | cyclobutyl | |
| 34 | H | H | CF₃ | OCH₂ | CH₃ | H | cyclobutyl | |
| 35 | H | H | CF₃ | O | CH₃ | H | cyclobutyl | |
| 36 | H | H | CF₃ | CH₂O | CH₃ | H | cyclopentyl | |
| 37 | H | H | CF₃ | OCH₂ | CH₃ | H | cyclopentyl | |
| 38 | H | H | CF₃ | O | CH₃ | H | cyclopentyl | |
| 39 | H | H | CF₃ | CH₂O | CH₃ | H | isobutyl | |
| 40 | H | H | CF₃ | OCH₂ | CH₃ | H | isobutyl | |
| 41 | H | H | CF₃ | O | CH₃ | H | isobutyl | |
| 42 | H | H | CF₃ | CH₂O | CH₃ | H | CH₃OCH₂ | |
| 43 | H | H | CF₃ | OCH₂ | CH₃ | H | CH₃OCH₂ | |
| 44 | H | H | CF₃ | O | CH₃ | H | CH₃OCH₂ | |
| 45 | H | H | CF₃ | CH₂O | CH₃ | H | (CH₃)₂N | |
| 46 | H | H | CF₃ | OCH₂ | CH₃ | H | (CH₃)₂N | |
| 47 | H | H | CF₃ | O | CH₃ | H | (CH₃)₂N | |
| 48 | H | H | CF₃ | CH₂O | CH₃ | H | 1-pyrrolidyl | |
| 49 | H | H | CF₃ | OCH₂ | CH₃ | H | 1-pyrrolidyl | |
| 50 | H | H | CF₃ | O | CH₃ | H | 1-pyrrolidyl | |
| 51 | H | H | CF₃ | CH₂O | CH₃ | H | 1-morpholyl | |
| 52 | H | H | CF₃ | OCH₂ | CH₃ | H | 1-morpholyl | |
| 53 | H | H | CF₃ | O | CH₃ | H | 1-morpholyl | |
| 54 | H | H | CF₃ | CH₂O | H | H | cyclopropyl | |
| 55 | H | H | CF₃ | OCH₂ | H | H | cyclopropyl | |
| 56 | H | H | CF₃ | O | H | H | cyclopropyl | |
| 57 | H | H | CF₃ | CH₂O | F | H | cyclopropyl | |
| 58 | H | H | CF₃ | OCH₂ | F | H | cyclopropyl | |
| 59 | H | H | CF₃ | O | F | H | cyclopropyl | |
| 60 | H | H | CF₃ | OCH₂ | Cl | H | cyclopropyl | |
| 61 | H | H | CF₃ | CH₂O | CH₃ | H | CH₃O | |
| 62 | H | H | CF₃ | OCH₂ | CH₃ | H | CH₃O | |
| 63 | H | H | CF₃ | O | CH₃ | H | CH₃O | |
| 64 | H | H | CF₃ | CH₂O | CH₃ | H | CH₃CH₂O | |
| 65 | H | H | CF₃ | OCH₂ | CH₃ | H | CH₃CH₂O | |
| 66 | H | H | CF₃ | O | CH₃ | H | CH₃CH₂O | |
| 67 | H | H | CF₃ | CH₂O | CH₃ | H | cyclopropyl | |
| 68 | H | H | CF₃ | OCH₂ | CH₃ | H | cyclopropyl | |

### EXAMPLE 4

Determination of the herbicidal activity and phytotoxicity in pre-emergence.

The herbicidal activity of the compounds of the invention in pre-emergence was evaluated according to the following operating procedure.

The vegetable species of interest (weeds or crops) were planted in vases having a diameter of over 10 cm, a height of 10 cm and containing sandy soil. 10 vases were used for each vegetable species.

The vases were divided into a further two groups each containing 5 vases for each weed or crop.

24 hours after planting, the vases were dampened with a light shower. An hour after wetting, the first group of vases was treated with a hydro-acetone dispersion containing acetone at 10% v, the product to be evaluated at the desired concentration and Tween 20 at 0.5%.

The second group was only treated with a hydroacetone solution containing acetone at 10% by volume and Tween 20 at 0.5%, and was used as a comparison (blank).

After the treatment, all the vases were uniformly watered and kept in a conditioned environment under the following environmental conditions:

temperature: 24° C.

relative humidity: 60%

photoperiod: 16 hours

light intensity: 10,000 lux

28 days after treatment, the herbicidal activity was evaluated on the basis of the following scale of values referring to the percentage of damage measured on the treated plants with respect to those not treated (blank):

0=0-9% damage

1=10-29% damage

2=30-49% damage

3=50-69% damage

4=70-89% damage

5=90% damage—death of the plant

Table 3 indicates the results obtained with compounds C-1, C-2 and C-3, evaluated at a dose of 500 g/ha on the following vegetable species:

Amarantus retroflexus (AR), Capsella bursa pastoris (CP), Chenopodium album (CA), Galium aparine (GA), Matricaria chamomilla (MC), Papaver rhoeas (PR), Portulaca oleracea (PO), Stellaria media (SM), Alopecurus myosuroides (AM), Panicum dicothomiflorum (PD), maize (M), wheat (F).

TABLE 3
Herbicidal activity in pre-emergence at a dose of 500 g/ha

| | Vegetable | | | | | | | | | | | |
|---|---|---|---|---|---|---|---|---|---|---|---|---|
| Compound | AR | CP | CA | GA | MC | PR | PO | SM | AM | PD | M | F |
| C-1 | 5 | 5 | 5 | 5 | 5 | 5 | 5 | 5 | 5 | 5 | 0 | 0 |
| C-2 | 5 | 5 | 5 | 5 | 5 | 5 | 5 | 5 | 5 | 5 | 0 | 0 |
| C-3 | 5 | 5 | 5 | 5 | 5 | 5 | 5 | 5 | 5 | 5 | 0 | 0 |

1. Compounds having general formula (I): 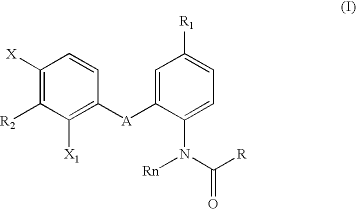
wherein:
R represents a hydrogen atom, a C₁-C₈ alkyl or haloalkyl group, a C₂-C₈ alkoxyalkyl or haloalkoxyalkyl group, a C₂-C₈ alkenyl or haloalkenyl group, a C₂-C₈ alkinyl or haloalkinyl group, a C₃-C₈ cycloalkyl or C₄-C₉ cycloalkylalkyl group optionally substituted by halogen atoms and/or C₁-C₄ alkyl or haloalkyl groups, a C₁-C₈ alkoxyl or haloalkoxyl group, an NRₐR_{b} group;
Rₐ and R_{b}, the same or different, represent: a hydrogen atom; a C₁-C₈ alkyl group; a phenyl group or a benzyl group optionally substituted by halogen atoms, by CN groups, NO₂ groups, C₁-C₄ alkyl, haloalkyl, alkoxyl, haloalkoxyl groups; or Rₐ and R_{b} jointly represent a C₂-C₈ alkylene chain optionally interrupted by oxygen atoms;
Rₙ represents a hydrogen atom, or a C₁-C₄ alkyl or haloalkyl group;
R₁ represents a hydrogen atom, a halogen atom, a C₁-C₄ alkyl or haloalkyl group, a C₁-C₄ alkoxyl or haloalkoxyl group, a C₁-C₄ alkylthio or haloalkylthio group, a cyano group, a nitro group;
R₂ represents a C₁-C₄ alkyl, haloalkyl, alkoxyl, haloalkoxyl, alkylthio or haloalkylthio group, or a halogen atom;
X and X₁, the same or different, represent a hydrogen atom or a halogen atom;
A represents an oxygen atom, a —CR₃R₄O— group, an —OCR₃R₄— group wherein R₃ and R₄, the same or different, represent a hydrogen atom or a C₁-C₄ alkyl, haloalkyl group.

2. A process for the preparation of the compounds having general formula (I) wherein an amine derivative having general formula (II) is reacted with a compound having general formula (III), according to reaction scheme 1: 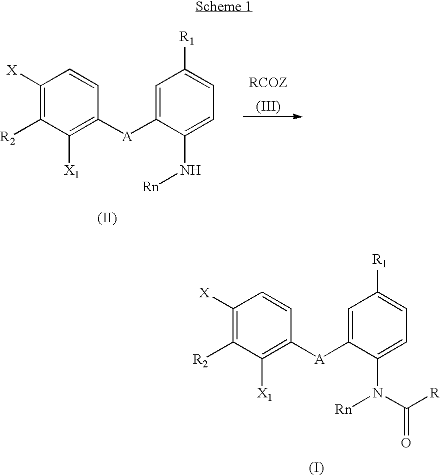
wherein R, Rₙ, R₁, R₂, X, X₁ and A have the meanings described above, Z represents a halogen atom, an alkoxyl group, a hydroxyl group.

3. The process according to claim 2, wherein Z represents a halogen atom and the reaction is carried out in an inert solvent and in the presence of an organic or inorganic base at a temperature ranging from −20° C. to the boiling point of the reaction mixture.

4. A process for the preparation of compounds having general formula (I) wherein A represents a —CR₃R₄O— group comprising the condensation of a derivative having general formula (IV) with a phenol having general formula (V), to give an ether having general formula (Ia) according to reaction scheme 2: 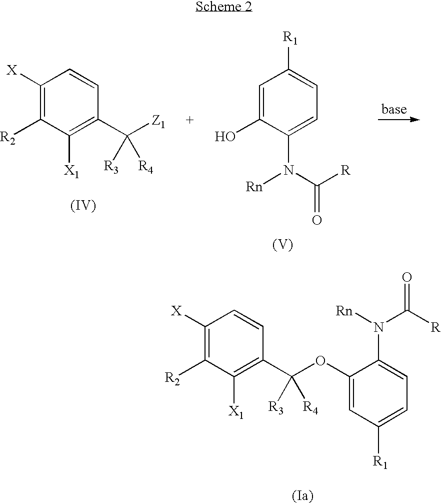
wherein R, Rₙ, R₁, R₂, R₃, R₄, X and X₁ have the meanings previously defined, Z₁ represents a halogen atom, or an R_{z}SO₃ group wherein R_{z} represents a C₁-C₄ alkyl group or a phenyl group optionally substituted by C₁-C₄ alkyl groups, and the reaction is carried out in the presence of one or more inert organic solvents and a base, at a temperature ranging from −10° C. to the boiling point of the reaction mixture.

5. A process for the preparation of the compounds having general formula (I) wherein A represents an —OCR₃R₄— group, which comprises the reaction of a phenol having general formula (VI) with a derivative having general formula (VII), to give an ether having general formula (Ib) according to reaction scheme 3: 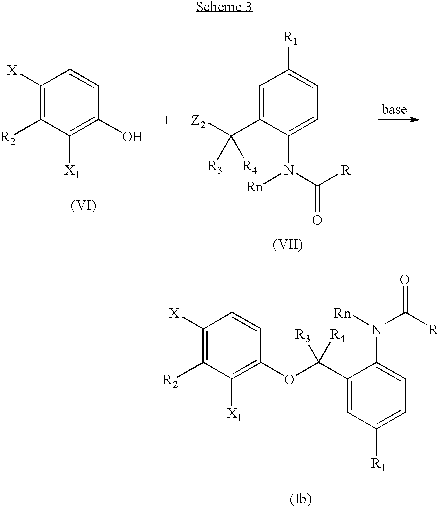
wherein R, Rₙ, R₁, R₂, R₃, R₄, X and X₁ have the meanings previously defined, Z₂ represents a halogen atom, or an R_{z}SO₃ group wherein R_{z} represents a C₁-C₄ alkyl group or a phenyl group optionally substituted by C₁-C₄ alkyl groups and the reaction is carried out in the presence of one or more inert organic solvents and a base, at a temperature ranging from −10° C. to the boiling point of the reaction mixture.

6. Use of the compounds according to claim 1 as herbicides.

7. Herbicidal compositions comprising solid carriers, liquids diluents, surface-active agents or other special additives and at least one of the compounds according to claim 1.

8. The compositions according to the previous claim, wherein the concentration of the compounds ranges from 1 to 90%.

9. The compositions according to claim 8 also comprising other herbicides.

10. A method for controlling weeds in cultivated areas which consists in applying a compound according to claim 1 or a composition according to claim 7, to said areas.

11. The method according to claim 10, wherein the active compounds are applied at doses ranging from 1 g to 1000 g per hectare.
